(19) United States
(12) Patent Application Publication
(10) Pub. No.: US 2015/0380157 A1
(43) Pub. Date: Dec. 31, 2015

(54) COIL UNIT AND DEVICE FOR THE INDUCTIVE TRANSFER OF ELECTRICAL ENERGY

(71) Applicant: CONDUCTIX-WAMPFLER GMBH, Weil am Rhein (DE)

(72) Inventors: Andrew GREEN, Malsburg-Marzell (DE); Veit PFÄTTISCH, Ingolstadt (DE)

(21) Appl. No.: 14/765,761

(22) PCT Filed: Feb. 4, 2014
(86) PCT No.: PCT/EP2014/052136

§ 371 Date: Aug. 4, 2015

(30) Foreign Application Priority Data
Feb. 5, 2013 (DE) 10 2013 101 150.0

(51) Int. Cl. H01F 38/14; H01F 27/28; H02J 5/00; H01F 27/24

(52) U.S. Cl. CPC H01F 38/14; H01F 27/24; H01F 27/2823; H02J 5/005

(57) ABSTRACT

A coil unit for the inductive transfer of electrical energy, including a coil and a flux guide unit for guiding a magnetic flux generated during operation of the coil, with the coil and/or the flux guide unit surrounded by stray field screening, and a device for the inductive transfer of electrical energy between a fixed primary coil unit and a secondary coil unit mounted on a movable load. The coil unit and device for the inductive transfer of electrical energy have a small and weak stray field, do not exceed the desired specifications for the maximum flux density outside the vehicle, and improve the efficiency of inductive energy transfer to the vehicle having a coil unit in which the stray field screening is mounted at a lateral distance from the flux guide unit and the coil.

The invention concerns a coil unit in accordance with the preamble of claim 1, a device for the inductive transfer of electrical energy in accordance with the preamble of claim 20, and the use of the coil unit in accordance with the preamble of claim 22.

In the field of the inductive transfer of energy to movable loads, particularly electric land vehicles such as automobiles, buses, or trucks, but also trains, the charging of batteries installed in the electric vehicles by a secondary coil located on the vehicle bottom from a fixed primary coil is known.

Such a battery charging system for use in the charging of a battery in an electric vehicle is disclosed by DE 693 13 151 T2. There, the user must, however, manually connect a primary coil package with a secondary coil package on the vehicle. This has the disadvantage that the user must climb down and connect the primary coil package with the secondary coil package in an elaborate and complicated manner.

Especially in dealing with buses and road vehicles which are, partially or completely, electrically driven, however, there is the desire to charge the vehicle battery simply and quickly, automatically, without an elaborate operation. To this end, the primary coil is, as a rule, located on or recessed in the road, and the vehicle is driven over the primary coil in such a way that the secondary coil is positioned as precisely as possible over the primary coil. Subsequently, only the charging process must be activated so that the primary coil located on the ground can transfer electrical energy to the nearby secondary coil on the vehicle bottom. In particular with buses, it is desirable that they are quickly and automatically charged during the short stop at a bus stop while passengers are getting on and off, without the bus driver having to get out and inconveniently align the primary and secondary coils.

With passenger cars, it is advantageous for this to take place while parked in a garage or in a parking lot. There, it is also desired that the charging should, to the greatest extent possible, take place automatically, so as to also make possible a simple and safe charging for vehicle users, who often possess few technical skills.

However, since it is precisely road vehicles which necessarily require a sufficient ground clearance, a height distance between the primary coil and the secondary coil is, as a rule, relatively large, for example, between 15 and 20 cm. Because of this large distance, which for the inductive device represents a large air gap and thus magnetic resistance, relatively high magnetic field strengths must be established for the inductive transfer of the electric energy from the primary coil to the secondary coil.

Known arrangements often make provision such that that the primary and secondary coils can be brought as close as possible to one another, by making use of additional lifting or lowering mechanisms, in order to be able to use the lowest field strengths possible. This, however, involves high technical and construction expenditure—above all, in that the vehicle weight is further increased. Preferably, in particular the secondary coil should be fixed on the vehicle such that the large distance between the coils is taken into account.

Experiments have shown that as a result of the great distance between the primary coil and the secondary coil and the necessary high magnetic field strength that results, a relatively strong stray field is produced. This impairs, on the one hand, the efficiency of the energy transfer and, on the other hand, produces very high field strengths spatially, even far away from the primary and secondary coils. As a result of electromagnetic compatibility and to avoid endangering anyone in the area of the primary coil units, it is desired, as a rule, that the magnetic flux density in the area next to the vehicle not exceed 6.25 μTesla. This requirement, however, cannot be met with traditional primary coil units and secondary coils on vehicles.

US 2010/0 007 215 A1 discloses a contactless transfer system with a coil that is located on a flux guide unit made of a soft magnetic material. The coil is, furthermore, surrounded by a ring-shaped stray field screening made of a soft magnetic material, which lies on the flux guide unit.

DE 10 2011 107 620 A1 discloses a coil arrangement in electric road vehicles. For the guiding of flux, a ferrite plate is used there, on which lie the coil windings.

DE 10 2010 050 935 A1 discloses a device for the contactless transfer of electrical energy, in which a coil is placed on a ferrite arrangement consisting of a large number of ferrite plates.

U.S. Pat. No. 5,656,983 A discloses an inductive coupler with two disk-shaped ferrite cores with an inner cylinder for the coil windings and an outer circular wall. The front sides of the ferrite cores, which face each other, are coated with a thin protective layer of a magnetically highly conductive material. In this way, the front sides are, on the one hand, protected against external mechanical effects and, on the other hand, a good magnetic conductivity is attained.

DE 10 2005 051 462 A1 discloses an inductive rotary transferring unit with a primary part and a secondary part, wherein the primary part has a primary coil and a primary core and the secondary part has a secondary coil and a secondary core. The primary core or the secondary core has a segment with at least two magnetic, especially soft magnetic, layers, which are arranged at least partially above one another.

DE 10 2011 054 541 A1 and DE 20 2011 051 649 U1 disclose a device for the inductive transfer of electrical energy with a coil and a plate-shaped flux guide unit for the guidance of a magnetic flux that appears during the operation of the device, with at least one ferromagnetic body consisting of a large number of individual elements.

U.S. Pat. No. 8,008,888 B2 discloses an electrically driven vehicle and a power supply device for the vehicle, wherein reflecting walls there, which are made of poorly magnetically conductive materials, reflect the magnetic flux in the direction of the power transfer.

The goal of the invention, therefore, is to overcome the aforementioned disadvantages and to provide a coil unit, mentioned in the beginning, a device, also mentioned in the beginning, for the inductive transfer of electrical energy, and the use of such a coil unit, which have a spatially small stray field and, in particular, meet the desired specifications for the maximum limiting values for the flux density that is desired outside the vehicle. In addition, the efficiency of the inductive energy transfer to the vehicle should be improved.

This goal is attained by the invention with a coil unit with the features of claim 1, a device for the inductive transfer of electrical energy with the features of claim 20, and a use of the coil unit with the features of claim 22. Advantageous developments and an appropriate refinement of the invention are given in the subclaims.

In accordance with the invention, the coil unit mentioned in the beginning is characterized in that the coil and/or the flux guide unit are surrounded by a stray field screening. In this way, the stray flux outside the coil can be clearly reduced and specified limiting values for the magnetic flux density are maintained. The stray field screening is thereby placed at a lateral distance from the flux guide unit—that is, in a top view of the coil and the flux guide from above, as shown in FIGS. 2, 4, 6, 8, and 10 to 15, and thus separated magnetically by an air gap or a magnetically poorly conductive material, or even a nonconductive material, from the flux guide unit and the coil. By this separation of the stray field screening from the flux guide unit and the coil, the screening of the stray field is improved, since the stray field screening is not used hereby for the guiding of the main flux. Also, the distance between the stray field screening and the coil and/or the flux guide unit can differ in different directions, especially if the coil protrudes only partially beyond the flux guide unit.

Preferably, the stray field screening can surround the coil and/or the flux guide unit in or parallel to a winding plane of the windings of the coil, wherein a flat structure that is more favorable, especially for electric vehicles and their charging stations, can be attained. To this end, the coil can advantageously be a flat coil with coil windings that are arranged next to one another or partially overlapping one another. Likewise, the flux guide unit and/or the stray field screening can be designed to be completely or at least partially flat, in order to obtain a flat structure. Preferably, the flux guide unit and/or the stray field screening can be made of a ferromagnetic or ferromagnetic material or a combination of the two, in order to attain a good guiding of the magnetic flux.

In an embodiment that is favorable for production, transporting, and installing, the coil, the flux guide unit, and the stray field screening can be connected firmly with one another, in particular, be cast, pressed, or screwed with one another, or combinations thereof.

Preferably, the coil can be a single-phase coil with a coil winding, a double D-coil with two coil windings, a three-phase coil with three coil windings, or a solenoid coil wound around the flux guide unit. In this way, with a simultaneous flat design, a good inductive energy transfer is made possible. Preferably, outer areas of the coil windings can protrude laterally beyond the flux guide unit, so that weight and costs can be reduced.

In an advantageous embodiment, the stray field screening can have a frame or ring that is located at a lateral distance to the coil. Advantageously, the lateral distance can hereby be one-sixth of a coil width from the outer coil windings opposite one another in the distance direction. Preferably also, a width of the stray field screening can be at least one-fourth, preferably one-third of a coil width from the outer coil windings opposite one another in the distance direction. In this way, one can greatly reduce the stray flux outside the coil. Preferably, the stray field screening can thereby be located coaxial to a winding axis or an outer circumference of the windings of the coil, in order to attain a uniform distribution of the magnetic stray flux and so as not to disadvantageously influence the main flux.

In a preferred refinement, the stray field screening can consist of a large number of individual partial elements, especially strips and/or plates, of a magnetically highly conductive material. In this way, the production and installation are facilitated since smaller strips and plates do not break as easily and are simpler to handle. In order to obtain a good magnetic circuit with few air gaps between the partial elements, they can be arranged and/or held flush against one another.

So as to make it advantageous for production technology, a holder can have recesses for the fixing of the stray field screening before the production of the coil unit, in particular before the casting, pressing, or screwing, or some other means of connecting with the coil and the flux guide unit. Furthermore, the holder can thereby have a recess for the holding and fixing of the flux guide unit before the production of the coil unit, in particular before the casting, pressing, or screwing, or some other means of connecting with the coil and the stray field screening.

In a favorable embodiment, the holder can be made of a material that is permeable to the magnetic field of the coil, in particular plastic, in order not to impair the magnetic flux. Alternatively, the holder can consist, at least in part, in particular, of a part that corresponds to a base plate of the coil unit and is made of a material that screens the magnetic field, in particular aluminum, in order to prevent the magnetic field from penetrating the bottom area of the vehicle.

Preferably, the recesses can be just deep enough so that they hold, at least in part, the stray field screening, so that the holder remains relatively flat. Alternatively, the recesses can be so deep that they completely hold the stray field screening, so that the stray field screening remains well protected against effects from the outside, even during production.

Preferably, the flux guide unit and the stray field screening can be arranged in essentially the same plane, wherein, above all, the lateral extension of the stray field can be advantageously further reduced. Viewed perpendicular to the plane, the stray field screening and the flux guide unit can also have the same thickness or different thicknesses; therefore, the stray field screening can be thicker or thinner than the flux guide unit.

In accordance with the invention, the device for the inductive transfer of electrical energy, mentioned in the beginning, is characterized in that the primary coil unit and/or the secondary coil unit are/is designed as described above and below.

Furthermore, in accordance with the invention, the coil unit described above and below can be used as a fixed primary coil unit and/or secondary coil unit of a movable load, in particular, an electric vehicle, with a device for the inductive transfer of electrical energy between a primary coil of the primary coil unit and a secondary coil of the secondary coil unit of the movable load.

Other features and advantages of the invention can be deduced from the following description of preferred embodiment examples with the aid of the drawings. The figures show the following:

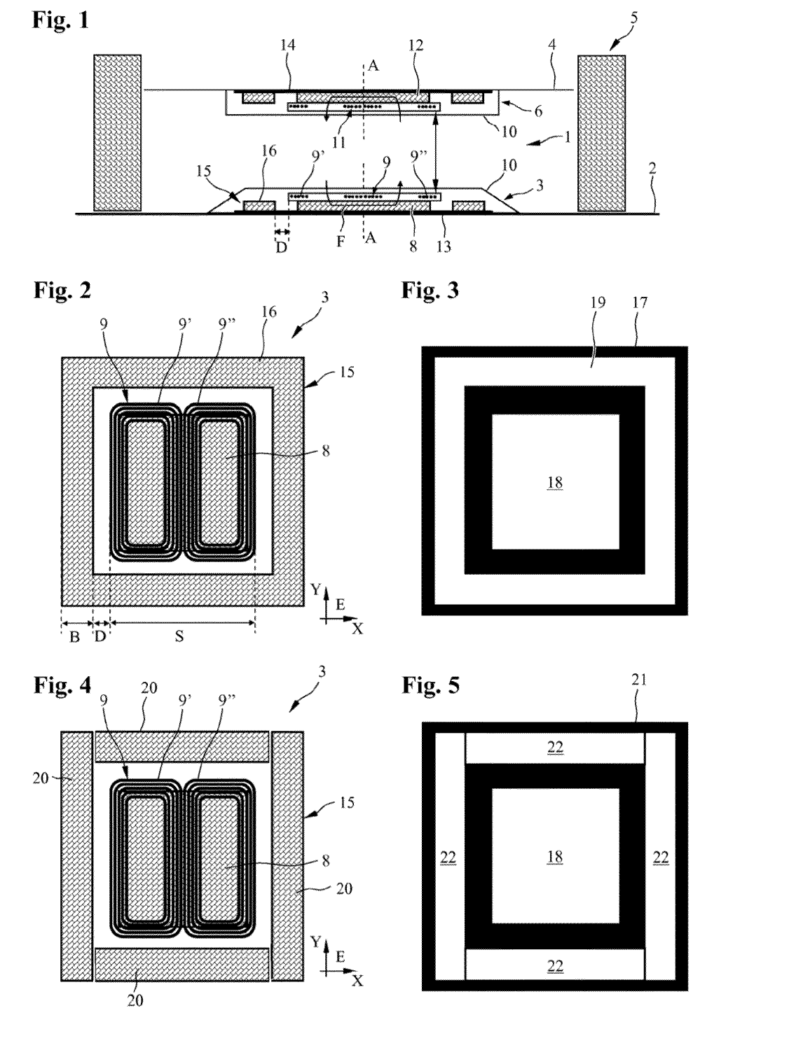

FIG. 1, a schematic sectional view of a device in accordance with the invention, transverse to the longitudinal direction of a vehicle to be charged;

FIG. 2, a schematic top view of a coil unit in accordance with the invention from FIG. 1;

FIG. 3, a schematic top view of a first holder for the coil unit from FIG. 2;

FIG. 4, a schematic top view of an alternative embodiment of a coil unit in accordance with the invention;

FIG. 5, a schematic top view of a second holder for the coil unit from FIG. 4;

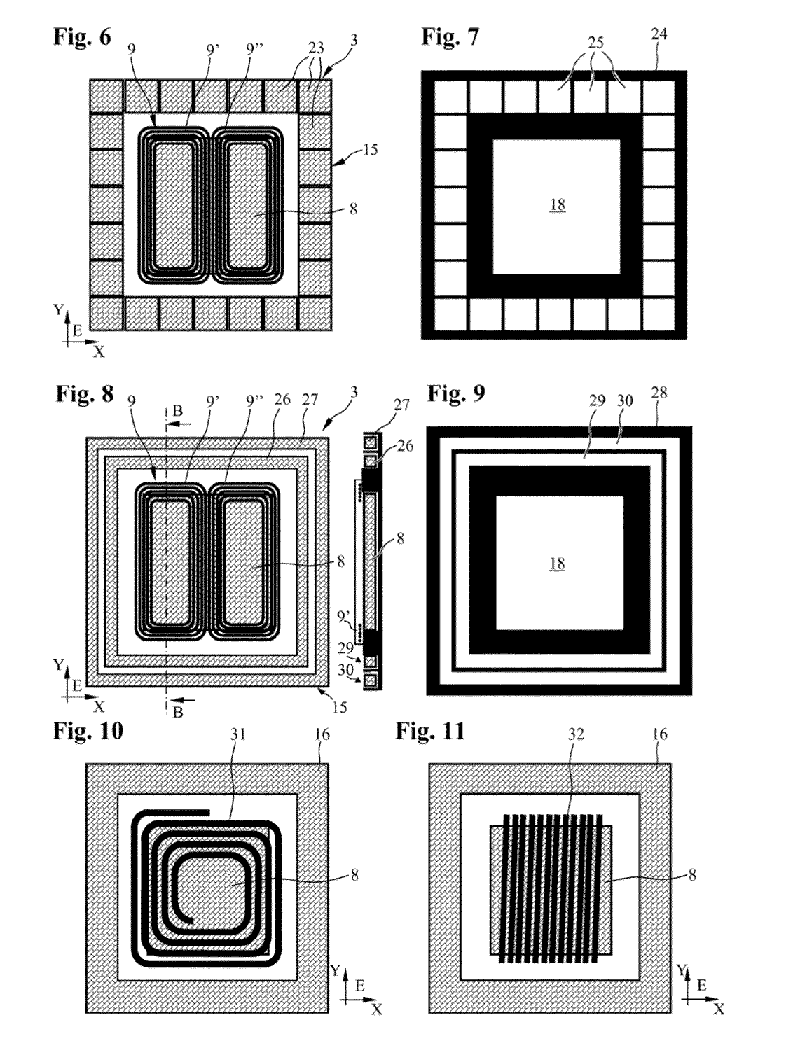

FIG. 6, a schematic top view of another alternative embodiment of a coil unit in accordance with the invention;

FIG. 7, a schematic top view of a third holder for the coil unit from FIG. 6;

FIG. 8, a schematic top view of a modification of the coil unit in accordance with the invention from FIG. 2, and a sectional view along the line B-B;

FIG. 9, a schematic top view of a fourth holder for the coil unit from FIG. 8;

FIG. 10, a schematic top view of an alternative embodiment of a coil unit in accordance with the invention;

FIG. 11, a schematic top view of a modification of the coil unit from FIG. 10;

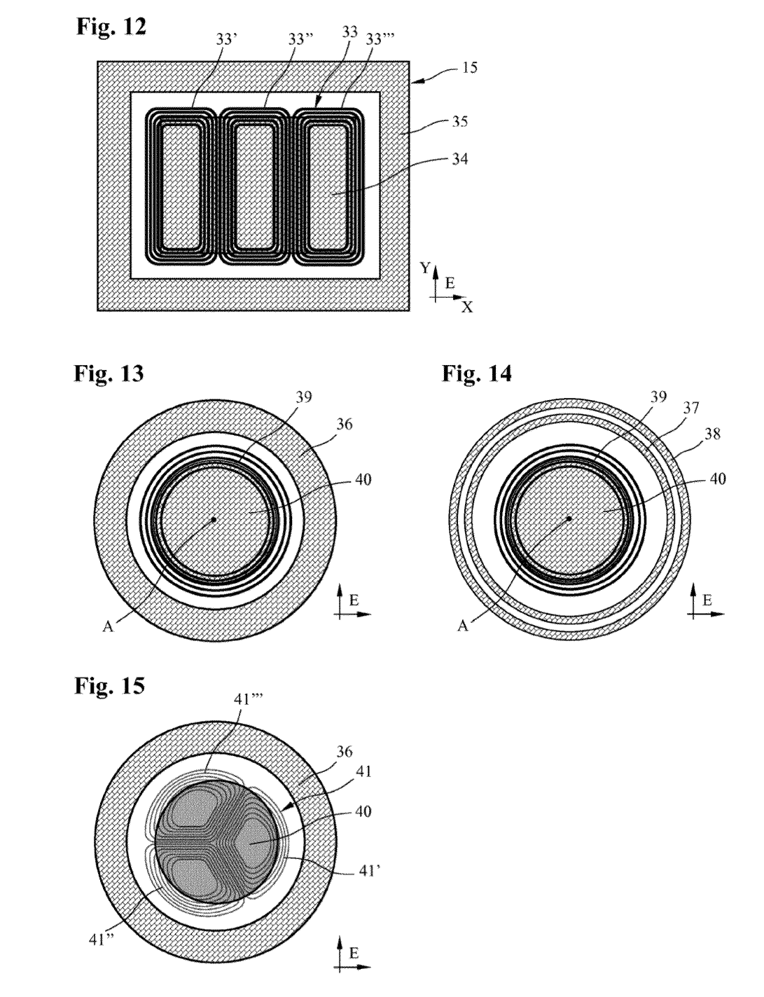

FIG. 12, a schematic top view of the coil unit from FIG. 2 with an alternative single-phase coil;

FIG. 13, a schematic top view of an alternative embodiment of a coil unit in accordance with the invention;

FIG. 14, a schematic top view of an alternative embodiment of a coil unit in accordance with the invention;

FIG. 15, a schematic top view of an alternative embodiment of a coil unit in accordance with the invention.

FIG. 1 shows a schematic sectional view through a device 1 in accordance with the invention, for the inductive transfer of electrical energy between a primary coil unit 3 in accordance with the invention, located on a road 2, and a secondary coil unit 6 in accordance with the invention, located on a vehicle bottom 4 of an electric vehicle 5.

As can be seen from FIG. 1, the primary coil unit 3 is placed above the road 2. Just as well, however, the primary coil unit 3 can also be recessed in or under the road 2. Also, the secondary coil unit 6 can be integrated into the vehicle bottom 4. As can be readily seen, a height distance H between the primary coil unit 3 and the secondary coil unit 6 is relatively large and is usually between 10 and 20 cm.

The primary coil unit 3 has a housing 7, with a flux guide unit 8 and a primary coil 9 placed thereon. The housing 7 is made of a magnetically permeable material, preferably plastic. The flux guide unit 8 and the primary coil 9, made of a ferro- or ferrimagnetic material, are cast into the housing 7 in a magnetically permeable material, in particular plastic. Instead, they can also be screwed with one another or pressed with plastic layers or plates. The structure and the materials for the primary coil 9 and the flux guide unit 8 are basically known to the specialist.

Also, the secondary coil unit 6 shown in FIG. 1 has, in turn, a housing 10 with a secondary coil 11, which is integrated therein, and a flux guide unit 12, which is made of a ferro- or ferrimagnetic material. The structure and the materials for the secondary coil 11 and the flux guide unit 12 are, in fact, known to the specialist.

Preferably, the flux guide units 8 and/or 12 can be provided, on their side turned away from the individual coil 9 or 11, with base plates 13, 14 for screening the magnetic flux, and which are made, for example, of aluminum.

The housings 7 and 10 are used to prevent contact with the current- and voltage-conducting components, the coil units 3, 6, and to protect them from mechanical damage. For better representation, the housings 7, 10 and the base plates 13, 14 are not drawn in FIGS. 2 to 10.

The coils 9, 11 are designed identically in the embodiment under consideration, so that below, the invention is described, above all, with the aid of the primary coil 9. Corresponding data are analogously valid for the secondary coil 11.

The primary coil 9 is designed as a flat, so-called double-D coil (see DE 10 2011 054 541 A1) with windings 9′, 9″ laid spiral-shaped and next to one another in a winding plane E, wherein they are laid here at right angles with rounded corners, but they can also be laid in the shape of a circular spiral. Winding axes A, A′ of the coil windings 9′, 9″ are perpendicular to the winding plane E—that is, perpendicular to the paper plane in FIGS. 2 to 10. The drawings merely show the coil 9 in the form of concentric windings, which, however, are spirally wound into one another in a known manner. In these figures, the transverse direction X, already drawn in FIG. 1, is drawn transverse to the longitudinal direction Y of the vehicle 5 and the longitudinal direction Y. If necessary, the incorporation of the coil unit 3 into the vehicle 5, however, can also be carried out in other directions—among others, rotated by 90° in the winding plane E.

The windings 9′, 9″ are thereby so firmly connected with one another or, during operation, are connected or supplied with current in such a way that the field line course F, indicated in FIG. 1, for the main magnetic flux, which is decisive for the inductive energy transfer, is produced, wherein the fluxes of the windings 9′, 9″ are added in a known manner and do not cancel each other out. The flux guide unit 8 is thus used to channel the main magnetic flux of the two windings 9′, 9″ through the winding-free areas of the windings 9′, 9″. Preferably, therefore, the windings 9′, 9″ can go out laterally beyond the flux guide unit 8 in a known manner.

Instead of the coils 9 and 11 shown in the figures, other types of coils can also be used—for example, double-, three-, or also multiphase coils with a corresponding number of coil windings that are next to one another or that partially overlap.

Below, the invention is explained with the aid of the primary coil unit 3; corresponding statements can be deduced analogously for the secondary coil unit 6.

Surprisingly, measurements have shown that the stray field and the magnetic stray flux density of the primary coil 9, supplied with current, are clearly reduced if the primary coil 9 and its flux guide unit 8 are surrounded by a stray field screening 15. In FIG. 2, the stray field screening 15 consists of a closed, rectangular, inner, open frame 16 made of a magnetically highly conductive material, in particular a ferro- or ferrimagnetic material. Such materials are basically known to the specialist and for that reason, it is not necessary to mention them in detail here; typical materials are, for example, manganese-zinc ferrites.

The frame 16 is located here in the same plane as the flux guide unit 8 and coaxial to the center of the coil 9, in order to bring about as uniform as possible a guiding of the stray field produced by the power-supplied primary coil 9. The frame 16 can, however, also be located somewhat higher or lower than the flux guide unit 8.

Preferably, a lateral distance D between the flux guide unit 8 and the inside of the frame 16 is at least one-sixth of the coil width S of the outer windings of coil windings 9, 9″, which are opposite one another in the distance direction. With reference to FIG. 2, this means that the distance direction runs horizontally—that is, in the direction of the double arrow D. Furthermore, the width B of the frame 16 can preferably be at least one-fourth, with particular preference at least one-third of the coil width S.

The same applies also to other forms of coils and stray field screenings. If the coil 9 in FIG. 2 were to have different coil widths, for example, in the X or Y direction, then for the different distance between the coil 9 and the frame 16 in the X or Y direction, the coil width between opposite coil windings in the distance direction to the adjacent part of the stray field screening is decisive. Also, the above data are valid with other forms, for example, of a hexagonal, octagonal, or other polygonal coil and a correspondingly shaped stray field screening and flux guide unit.

Furthermore, the distance D between the frame 16 and the flux guide unit 8 or the coil 9 can have different magnitudes in the X and Y direction, as is alluded to in FIG. 2.

Preferably, a first holder 17, shown in FIG. 3, has a rectangular recess 18 to hold the flux guide unit 8, and a surrounding, uninterrupted, frame-shaped recess 19 into which the frame 16 can be placed. In this way, it is possible to precisely position the laid parts for the casting of the primary coil unit 3 relative to one another, which is sensible for attaining as uniform as possible a magnetic field course.

By this arrangement, the stray field is concentrated around the stray field screening 15 and the flux density is clearly reduced outside the primary coil unit 3 so that the permitted and desired values of the magnetic flux density can already be attained close to the primary coil unit 3 under the vehicle 5. The same applies if, additionally or alternatively, a corresponding stray field screening is located around the secondary coil unit 6.

FIGS. 4 to 11 show alternative developments of the invention, which, however, utilize the same basic principle—namely, a preferably flat stray field screening that surrounds the individual coil 9, 11.

As is shown in FIG. 4, the stray field screening 15 from FIG. 2 can also consist of individual strips 20, uniformly designated with the reference number 20, which are made of the same material as the frame 16. In this way, production is simplified since the materials used break with relative ease and a frame 16 is therefore difficult to produce and to handle. Preferably, a second recess 21, shown in FIG. 5, has a rectangular recess 18 to hold the flux guide unit 8 and four strip-shaped recesses 22, uniformly designated with the reference number 22, into which the four strips 20 can be laid and fixed in a defined position for the casting, pressing, or screwing to the primary coil unit 3.

As is shown in FIG. 6, the stray field screening 15 from FIG. 2 can also be put together from individual smaller plates 23, which are laid next to one another and are uniformly designated with the reference number 23 and are made of the same material.

In this way, once again, production is simplified, since such small plates 23 break less readily and are better in handling. Preferably, a third holder 24, shown in FIG. 7, has a rectangular recess 18 to hold the flux guide unit 8 and plate-shaped recesses 25, uniformly designated with the reference number 25, into which the plates 23 can be laid and fixed for the casting, pressing, or screwing to the [omitted in source; probably primary coil unit 3].

Preferably, the strips 20 or plates 23 are laid next to one another with the smallest possible distance; the crosslinks of the recesses 22 or 25 between the strips 20 or plates 23 should therefore be as thin as possible.

Alternatively, the four strips 20 or the plates 23 can also be laid in the frame-shaped recess 19 and can be clamped relative to one another by means of preferably wedge-shaped spacers, not shown, that are shoved between the strips 20 or the plates 23, so as to be able to specify a defined position for the casting. Also, in this embodiment, the strips 20 or the plates 23 can also be made so wide that they completely fill the frame-shaped recess 19 and are thus fixed relative to one another. In this way also, a magnetically highly conductive connection can be provided between the strips 20 or plates 23.

Also, the strips 20 or the plates 23 can thereby be advantageously made so wide that they completely fill the frame-shaped holder and are fixed relative to one another. In this way, also, a magnetically highly conductive connection between the strips 20 or plates 23 can be provided.

In the embodiment according to FIG. 8, the stray field screening consists of rectangular frames arranged coaxially around the primary coil 9 and coplanar to the flux guide unit 8, and an inner space 26 and an outer space 27, which are arranged at a uniform distance to one another. Like the frame 16 from FIG. 2, the frames 26 and 27 are made, once again, of a magnetically highly conductive material, in particular, a ferro- or ferrimagnetic material. By means of this embodiment, the stray field is not reduced quite as much as with the embodiment according to FIG. 2, but ferro- or ferrimagnetic material is saved, wherein the weight and also the costs are reduced. Preferably, the weight-saving embodiment is used with the secondary coil unit 6 on the vehicle 5.

FIG. 9 shows a fourth holder 28 to hold the inner frame 26 and the outer frame 27. As is shown in FIG. 8, to the right of the section along the line B-B, the flux guide unit 8, the inner frame 26 and the outer frame 27 are fixed in the fourth holder 28. The fourth holder 28 has rectangular, frame-shaped recesses 29, 30 for the inner frame 26 and the outer frame 27. The holder 28 holds the flux guide unit 8, the inner frame 26, and the outer frame 27 in their position before the casting, pressing, or screwing to the primary coil unit 3 and thus produces a defined, as precise as possible distance of the held parts from one another, in order to reduce or to completely avoid a lack of symmetry in the magnetic field and flux distribution.

The holders 17, 21, 24, and 28 are used for the precise positioning of the various stray field screenings before the casting, pressing, or screwing with the primary coil 9 and the flux guide unit 8 and thus provide a defined, as precise as possible distance of the held parts from one another. Preferably, the holders 17, 21, 24, and 28 are made from a magnetically permeable material, preferably plastic.

To achieve a flat design of the secondary coil unit 6, the holders 17, 21, 24 and 28 can also be made of aluminum or consist of another magnetic field screening material, so that base plate 14 can be dispensed with.

In order to further save material and to reduce the design of the secondary coil unit 6 even more, the recesses 18, 19, 22 or 25 can also be just deep enough there so that the stray field screenings 16, 20, 23, 26, or 27 are held in their position during the casting.

In the alternative coil unit shown in FIG. 10, instead of the double-D coil 9 shown in FIG. 2 as the only difference, a single-phase, flat-wound coil 31 is used. There also, the frame-shaped stray field screening 15 surrounds the flux guide unit 8 to reduce the stray field.

In the additional alternative coil unit shown in FIG. 11, instead of the double-D coil 9 shown in FIG. 2, a single-phase solenoid coil is used, which is wound around the flux guide unit 8 in a known manner. In FIG. 13, only the windings running above the flux guide unit 8 are shown; the windings running under the flux guide unit 8 are not drawn for reasons of clarity of the representation.

In the additional alternative coil unit shown in FIG. 12, instead of the double-D coil 9 shown in FIG. 2, a three-phase coil 33 with three coil windings, which are wound lying on a correspondingly longer flux guide unit 34, is used.

The three windings 33, 33″, 33′″ are thereby so firmly connected with one another or are so connected or supplied with power during operation that the main magnetic flux, which is decisive for the inductive energy transfer, runs through the winding-free areas of the windings 33, 33″, 33′″. The fluxes of the windings 33, 33″, 33′″ are thereby added in a known manner and do not cancel each other. The flux guide unit 8′ is thus used here also to channel the magnetic flux of the windings 33, 33″, 33′″ through the winding-free areas of the windings 33, 33″, 33′″. Here too, the outer coil windings 33, 33′″ extend laterally beyond the flux guide unit 34.

In this coil 33, the coil width S, which is decisive for the distance D and the width B of the frame 35, is used as the distance between the opposite outer windings of the coil windings 33, 33′″, in the distance direction.

FIGS. 13 and 14 show alternative embodiments of the coil unit in accordance with FIGS. 2 and 8, wherein there, circular stray field screenings 36 and 37, 38 are arranged around a correspondingly circular primary coil 39 and flux guide unit 40. Otherwise, the statements made with regard to FIGS. 2 and 8 apply. Instead of the single-phase coil 39, a semi-circular double-D coil can also be used in accordance with FIG. 2.

FIG. 15 shows another alternative coil unit in accordance with FIG. 13, wherein here, instead of a single-phase, spiral-wound primary coil 39, a three-phase, triangularly wound coil is used. The three windings of the coil are thereby so firmly connected with one another or are so connected or supplied by power during operation that the main magnetic flux, which is decisive for the inductive energy transfer, runs through the winding-free areas of the winding. The fluxes of the windings are thereby added in a known manner and do not cancel each other. The flux guide unit 8′ is thus also used here to channel the main magnetic flux of the winding 41, 41″, 41′″ through the winding-free areas of the windings 41, 41″, 41′″. With this embodiment also, the outer parts of the windings 41, 41″, 41′″ extend beyond the flux guide unit 40, which is only alluded to in the drawing.

Instead of the coils shown in the drawings and described above, other types of coils can also be used, for example, multiphase coils with a corresponding number of coil windings. Also, the windings of the coils can be laid next to one another or can partially overlap. Moreover, the coil, the flux guide unit, and/or the stray field screening may, under certain circumstances, also not be completely planar, but rather be partially bent or form-adapted, in order to be able to adapt, in particular, the secondary coil, to the geometry of a vehicle bottom so as to save space. For example, with the coil unit 3 from FIG. 2, along the symmetry line, which is perpendicular in FIG. 2, a bend in the height direction can be provided between the windings 9, 9′.

### LIST OF REFERENCE SYMBOLS

1 Energy transfer device

2 Road

3 Primary coil unit

4 Vehicle bottom

5 Electric vehicle with indicated tires

6 Secondary coil unit

7 Housing, primary coil unit

8 Flux guide unit, primary coil

9 Primary coil (Double-D coil)

9′, 9″ Coil windings, primary coil

10 Housing, secondary coil unit

11 Secondary coil

12 Flux guide unit, secondary coil

13 Base plate, primary coil unit

14 Base plate, secondary coil unit

15 Stray field screening

16 Ferrite frames

17 First holder

18 Rectangular recess

19 Frame-shaped recess

20 Strips

21 Second holder

22 Strip-shaped recesses

23 Plates

24 Third holder

25 Plate-shaped recesses

26 Inner frame

27 Outer frame

28 Fourth holder

29 Frame-shaped inner recess

30 Frame-shaped outer recess

31 Single-phase coil

32 Solenoid coil

33 Three-phase coil

33′, 33″, 33′″ Coil windings, three-phase coil

34 Flux guide unit, three-phase coil

35 Rectangular ferrite frame, three-phase coil

36 Circular stray field screenings

37 Circular stray field screenings

38 Circular stray field screenings

39 Circular coil

40 Flux guide unit, circular coil

41 Circular three-phase coil

41′, 41″, 41′″ Coil windings, circular three-phase coil

A Winding axis

B Width of the stray field screening

D Distance coil or flux guide unit—stray field screening

E Winding plane

F Field line course

H Height distance of the coils

S Coil width

X Transverse direction vehicle

Y Longitudinal direction vehicle

1. Coil unit for the inductive transfer of electrical energy with a coil and a flux guide unit for the guiding of a magnetic flux that appears during the operation of the coil, wherein the coil and/or the flux guide unit are surrounded by a stray field screening, wherein the stray field screening is located at a lateral distance from the flux guide unit and the coil.

2. Coil unit according to claim 1, wherein the stray field screening surrounds the coil and/or the flux guide unit in or parallel to a winding plane of the coil winding of the coil.

3. Coil unit according to claim 1, wherein the coil is a flat coil with coil windings that are located next to one another or that partially overlap one another.

4. Coil unit according to claim 1, wherein the flux guide unit and/or the stray field screening are designed to be completely or at least partially flat.

5. Coil unit according to claim 1, wherein the flux guide unit and/or the stray field screening is formed from a ferromagnetic or ferrimagnetic material or a combination of the two.

6. Coil unit according to claim 1, wherein the coil, the flux guide unit and the stray field screening are firmly connected with one another, in particular they are cast, pressed, or screwed with one another.

7. Coil unit according to claim 1, wherein the coil is a single-phase coil with a coil winding, a double-D coil with two coil windings, a three-phase coil with the coil windings, or a solenoid coil which is wound around a flux guide unit.

8. Coil unit according to claim 1, wherein outer areas of the coil windings protrude laterally beyond the flux guide unit.

9. Coil unit according to claim 1, wherein the stray field screening has at least one frame or ring, which is located at a lateral distance to the coil and/or to the flux guide unit.

10. Coil unit according to claim 9, wherein the lateral distance is at least one-sixth of a coil width of the outer coil windings opposite one another in the distance direction.

11. Coil unit according to claim 9, wherein a width of the stray field screening is at least one-fourth, preferably one-third of a coil width of the outer coil windings opposite one another in the distance direction.

12. Coil unit according to claim 1, wherein the stray field screening is located coaxial to a winding axis or an outer circumference of the windings of the coil.

13. Coil unit according to claim 1, wherein the stray field screening includes a large number of individual partial elements, in particular strips and/or plates of a magnetically highly conductive material.

14. Coil unit according to claim 13, wherein the individual partial elements are arranged and/or maintained flush against one another.

15. Coil unit according to claim 1, wherein it has a holder with recesses for the fixing of the stray field screening before the casting, pressing, or screwing with the coil and the flux guide unit.

16. Coil unit according to claim 15, wherein the holder has a recess for the holding and fixing of the flux guide unit before the casting, pressing, or screwing with the coil and the stray field screening.

17. Coil unit according to claim 15, wherein the holder is made of a material that is permeable to the magnetic field of the coil, in particular plastic, or a material that screens the magnetic field, in particular aluminum.

18. Coil unit according to claim 15, wherein the recesses are so deep that they at least partially or completely hold the stray field screening.

19. Coil unit according to claim 1, wherein the flux guide unit and the stray field screening are essentially located in the same plane relative to one another.

20. Device for the inductive transfer of electrical energy between a primary coil of a fixed primary coil unit and a secondary coil of a secondary coil unit, located on a movable load, in particular an electric vehicle, for the inductive transfer of electrical energy with a coil and a flux guide unit for the guiding of a magnetic flux that appears during the operation of the coil, wherein the coil and/or the flux guide unit are surrounded by a stray field screening located at a lateral distance from the flux guide unit and the coil.

21. (canceled)

22. A system for inductive transfer of electrical energy comprising:
a movable load having a coil unit according to claim 1 as a fixed primary coil unit and/or a secondary coil unit of the movable load and a device for the inductive transfer of electrical energy between a primary coil of the primary coil unit and a secondary coil of the secondary coil unit of the movable load.
